(19) United States
(12) Patent Application Publication
(10) Pub. No.: US 2014/0006126 A1
(43) Pub. Date: Jan. 2, 2014

(54) AUTOMATIC REDEMPTION OF MANUFACTURER OFFERS

(71) Applicants: Clarence Christopher Mysen, San Francisco, CA (US); Kosuke Suzuki, Tokyo (JP)

(72) Inventors: Clarence Christopher Mysen, San Francisco, CA (US); Kosuke Suzuki, Tokyo (JP)

(73) Assignee: GOOGLE Inc., Mountain View, CA (US)

(21) Appl. No.: 13/540,379

(22) Filed: Jul. 2, 2012

(51) Int. Cl. G06Q 30/02

(52) U.S. Cl. 705/14.17; 705/14.25

(57) ABSTRACT

A method of automatic redemption of manufacturer offers comprises a loyalty card account linked to a remote offer redemption system. Manufacturers send offers to the remote system, wherein each offer comprises redemption rules and discount information. The user selects and saves offers to his remote system account and presents the loyalty account information to the merchant when making a purchase. The user's loyalty account information causes the transaction details to be forwarded to the merchant's loyalty backend, which determines that the user is registered with the remote system and forwards the transaction details to the remote system. The transaction details are analyzed to determine if the user has an offer that meets the redemption rules. If the user has an applicable saved offer, the offer is redeemed. The offer is marked as “redeemed,” and the user is notified of the redemption.

### TECHNICAL FIELD

The present disclosure relates generally to intelligent coupons, and more particularly to methods and systems that allow users to automatically redeem manufacturer offers using a loyalty card account linked to a third party remote system account.

### BACKGROUND

Merchants and manufacturers have offered coupons or rebates as incentives for purchasing particular products for some time. Traditionally, coupons are distributed in a paper format. A user redeems the coupon by physically taking it to a merchant and purchasing a product that satisfies the terms of the coupon. Such system is limited in that users are required to clip or print out paper coupons and present such coupons to the merchant to redeem the discount.

Other forms of traditional coupons include rebates for purchasing particular products, wherein after purchasing a product that satisfies the terms of the rebate offer, the user fills out and returns required forms to request the rebate. Such system is also limited in that the redemption is not automatically applied and the user is required to submit additional paperwork to receive the redemption at a later time. Additionally, because such rebates are usually requested and/or sent by mail, they carry a great deal of unreliability and hassle for the user.

More recently, merchants have offered electronic merchant coupons linked to merchant loyalty cards. A user enrolls in a merchant's loyalty program and receives a loyalty card. A user then associates certain merchant-specific discounts to the loyalty card and redeems these discounts by presenting the loyalty card (or some form of identifying information, such as a telephone number) and the method of payment to the merchant when purchasing the discounted products. In other circumstances, discounts are automatically associated with the loyalty card and are redeemed by presenting the loyalty card (or some form of identifying information, such as a telephone number) and the method of payment to the merchant when purchasing the discounted products. However, such systems are limited in that redemption is limited to merchant-specific discounts and/or the redemption occurs as a part of the payment processing transaction.

### SUMMARY

In certain exemplary aspects, a method and system of automatic redemption of manufacturer offers comprises a loyalty card account linked to a third party remote system. A user registers with the third party remote system and submits a request to link an existing merchant loyalty account to his/her remote system account. The remote system validates the user's loyalty account data and links the accounts. Once the accounts are linked, the user's loyalty account information is saved in a data storage unit resident at the remote system. Meanwhile, manufacturers send coupons to the remote system. In an alternative embodiment, this invention is not limited to manufacturer coupons or coupons in general. For example, merchants may send coupons, loyalty incentives, redemption offers or other types offers to the remote system. The offers comprise redemption rules that specify how the offer is to be matched to a user transaction and discount information that specifies the cash value or loyalty point exchange rate. The user selects and saves offers to his/her remote system account.

The user makes a purchase at the merchant and presents the loyalty account information. The user's loyalty account information causes the transaction details to be forwarded to the merchant's loyalty program system. The loyalty program system determines that the user is registered with the remote system and forwards the transaction details. The user's transaction details are stored in the data storage unit resident at the remote system. The transaction details are also analyzed to determine if the user has an offer for the purchase or items within the purchase that meet the redemption rules. If the user has a saved offer and the redemption rules are met, the offer is redeemed. Depending on the details of the discount, the user may be given cash back, loyalty points or some other form of credit for their purchase. The remote system may front the cash back fees to the user and then bill the manufacturer for the redeemed value. In an alternative exemplary embodiment, the remote system may notify the loyalty program system of the offer and the loyalty program system may front the cash back fees to the user. The remote system will invoice the manufacturer for the value of the offer, plus any applicable fees, and reimburse the loyalty program system for the redemption value of the offer. In an alternative embodiment, the manufacturer is billed and fees are received before the redemption is funded to the user. In an alternative exemplary embodiment, the user is provided with a non-cash redemption. In this embodiment, the remote system may notify the loyalty program system of the loyalty point value and the non-cash redemption is translated into a redemption value before the manufacturer is billed. The offer is marked as “redeemed” and the user is notified of the redemption.

These and other aspects, objects, features and advantages of the exemplary embodiments will become apparent to those having ordinary skill in the art upon consideration of the following detailed description of illustrated exemplary embodiments, which include the best mode of carrying out the invention as presently presented.

### BRIEF DESCRIPTION OF THE DRAWINGS

FIG. 1 is a block diagram depicting an operating environment for a system for automatic redemption of manufacturer offers according to an exemplary embodiment.

FIG. 2 is a block flow diagram depicting a method for automatic redemption of manufacturer offers according to an exemplary embodiment.

FIG. 3 is a block flow diagram depicting a method for linking a loyalty program system account to a remote system account according to an exemplary embodiment.

FIG. 4 is a block flow diagram depicting a method for associating manufacturer offers with a user's remote system account according to an exemplary embodiment.

FIG. 5 is a block flow diagram depicting a method for redemption of manufacturer offers by the remote system according to an exemplary embodiment.

FIG. 6 is a block flow diagram depicting a method for determining whether the user has a manufacturer offer for a purchase transaction according to an exemplary embodiment.

FIG. 7 is a block flow diagram depicting a method for redeeming manufacturer offers according to an exemplary embodiment.

### DETAILED DESCRIPTION OF EXEMPLARY EMBODIMENTS

### Overview

The exemplary embodiments provide methods and systems that enable users to automatically redeem manufacturer offers. A user registers with the remote system and submits a request to link an existing merchant loyalty account to his/her remote system account. The remote system validates the user's loyalty account data with the loyalty program account system and links the accounts. Once the accounts are linked, the user's loyalty account information is saved in a data storage unit resident at the remote system.

Meanwhile, manufacturers create offers and transmit them to the remote system. The offers comprise redemption rules that specify how the offer is to be matched to a user transaction, discount information that specifies the cash value or loyalty point exchange rate, and information describing which target users or users the offer is to be distributed to (for example, users who bought a competitor brand in the past). The offer content and discount may be personalized to a particular user. For example, user A may receive a 5% off coupon for a particular product while user B may receive a 10% off coupon for the same product. The remote system distributes the offers and selectively sends potential offers to the user. The remote system may determine which users qualify for a particular offer. The remote system may also rank and prioritize the offers sent to a user. The user selects and saves offers to his/her remote system account.

The user makes a purchase at the merchant and presents the loyalty account information. The purchase transaction is not limited to a credit or debit card transaction. The purchase transaction may be a cash transaction, loyalty point redemption transaction, prepaid offer redemption transaction, gift card transaction, or other form of non-traditional credit transaction. The user's loyalty account information causes the transaction details to be forwarded to the merchant's loyalty backend, either a third party loyalty management system or the merchant's loyalty management system.

The loyalty program system determines that the user is registered with the remote system and transmits the transaction details to the remote system. The user's transaction details are stored in the data storage unit resident at the remote system and are also analyzed to determine if the user has one or more offers for the purchase or items within the purchase that meet the redemption rules. The remote system reviews the saved offers and the transaction details to determine if the redemption rules for the offer are met.

If the user has a saved offer and the redemption rules are met, the offer is redeemed. Depending on the details of the discount, the user may be given cash back, loyalty points or some other form of credit for their purchase. The remote system may front the cash back fees to the user and then bill the manufacturer for the redeemed value. In an alternative embodiment, the manufacturer is billed and fees are received before the redemption is funded. In an alternative exemplary embodiment, the remote system may notify the loyalty program system that the offer was redeemed and the loyalty program system may provide the cash back, loyalty points, or other form of credit to the user. The remote system bills the manufacturer for the redeemed value and fees before sending the redeemed value to the loyalty program system. The offer is marked as “redeemed” and the user is notified of the redemption.

The functionality of the exemplary embodiments will be explained in more detail in the following description, read in conjunction with the figures illustrating the program flow.

### System Architecture

Turning now to the drawings, in which like numerals indicate like (but not necessarily identical) elements throughout the figures and exemplary embodiments are described in detail.

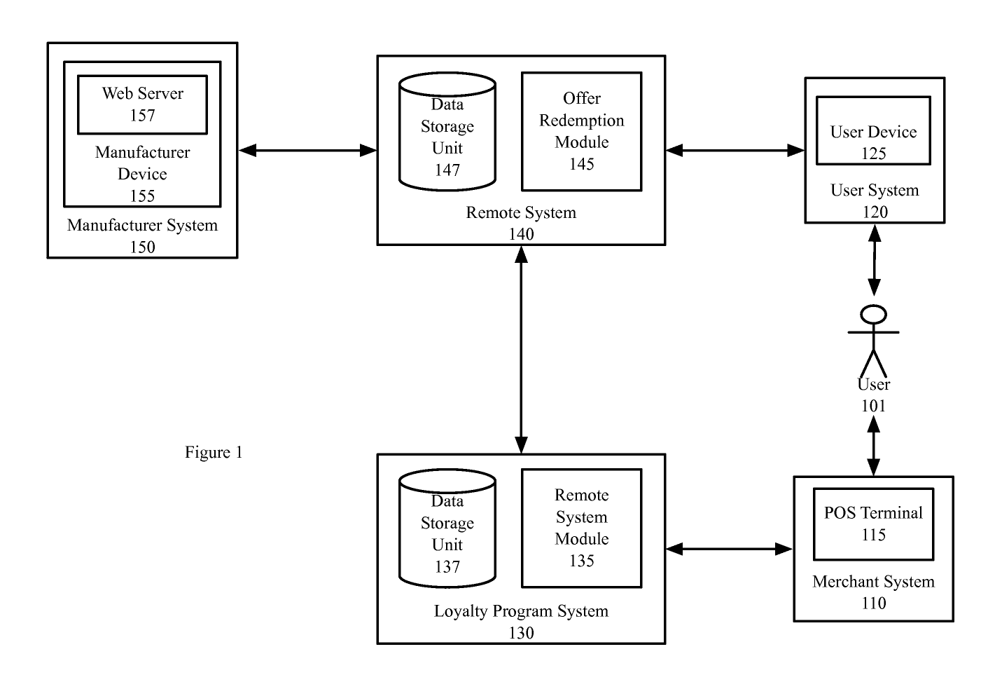

FIG. 1 is a block diagram depicting an operating environment 100 for automatic redemption of manufacturer offers. As depicted in FIG. 1, the exemplary operating environment 100 comprises a merchant system 110, a user system 120, a loyalty program system 130, a remote system 140 and a manufacturer system 150 that are configured to communicate with one another via one or more communication channels (not shown).

The merchant system 110 comprises a point of sale (“POS”) terminal 115 that is capable of processing a purchase transaction initiated by a user 101. In an exemplary embodiment, the merchant operates a commercial store and the user 101 indicates a desire to make a purchase by presenting a form of payment at the POS terminal 115. In an alternative exemplary embodiment, the merchant operates an online store and the user 101 indicates a desire to make a purchase by clicking a link or “checkout” button on a website. In an exemplary embodiment, the user presents a form of payment and a loyalty program identification (for example, a loyalty program card, phone number, loyalty program number, or some other form of identifying information) when the transaction is processed.

The merchant system 110 communicates the user's 101 loyalty program information to the loyalty program system 130. In an exemplary embodiment, the loyalty program is specific to a merchant or group of merchants. For example, a Best Buy loyalty program or a loyalty program for various restaurants. In an exemplary embodiment, the loyalty program information is processed outside of the payment transaction. In this embodiment, the payment is processed without interruption or dependence upon the loyalty program communication. In an exemplary embodiment, the loyalty program system 130 is a third party loyalty management system that operates independently or separately from the merchant system 110. In an alternative exemplary embodiment, the loyalty program system 130 is a component of the merchant system 130. In this embodiment, the loyalty program system 130 may be a component of the POS terminal 115, a system that operates to manage the loyalty program for a group of store (for example, a merchant system component that manages the loyalty programs for all Best Buys stores), or a system that operates to manage the loyalty program for a single store.

An exemplary loyalty program system 130 comprises a data storage unit 137 and a remote system module 135. The data storage unit 137 stores the user's loyalty program information, transaction information, remote system 140 account information, and other information as required for the operation of the loyalty program or method described herein. The data storage unit 137 can comprise one or more tangible computer-readable storage devices. The remote system module 135 receives the user's loyalty program information and determines whether the user's account is linked to a remote system account. If the user's account is linked, the remote system module 135 transmits the user's transaction information and identifying information to the remote system 140.

The remote system 140 is a third party system that manages a user account or credentials. The user 101 registers for a remote system account using the user system 120. An exemplary user system 120 comprises a user device 125. The user device 125 may be a personal computer, mobile device (for example, notebook, computer, tablet computer, netbook computer, personal digital assistant (“PDA”), video game device, GPS locator device, cellular telephone, Smartphone or other mobile device), or other appropriate technology that includes or is coupled to a web server (for example, Google Chrome, Microsoft Internet Explorer, Netscape, Safari, Firefox, or other suitable application for interacting with web page files). The user 101 can use the user device 120 to view, register, download, upload, or otherwise access the remote system 140 account. The user 101 can also use the user device 125 to access and select manufacturer offers. The selected offers are saved in the remote system's 140 data storage unit 147.

The user 101 may be automatically prompted with one or more manufacturer offers based on the user's registration information immediately after completing the registration process. In an alternative embodiment, the user 101 may be prompted to register with the remote system 140 when the user 101 clicks on or selects a manufacturer offer. In an alternative exemplary embodiment, the user 101 may use a smart phone application to register with the remote system 140. In another alternative exemplary embodiment, the user 101 may register with the remote system through the user's digital wallet.

In an exemplary embodiment, the manufacturer offers may be grouped (for example, as active offers, paused offers, pending offers, redeemed offers, and expired offers). Active manufacturer offers may include manufacturer offers that may be automatically applied to a future purchase. Paused manufacturer offers may include manufacturer offers that have been temporarily paused by the user 101 so that it will no longer be automatically applied. For example, the user 101 may set redemption rules (for instance, the redemption will only be applied if the user 101 spends more than $100). Pending manufacturer offers may include manufacturer offers that are in the process of being credited. Redeemed manufacturer offers may include manufacturer offers that have been previously applied by the user 101. Expired manufacturer offers may include manufacturer offers that are no longer accepted by the merchant system 110.

In an exemplary embodiment, the user 101 can view purchase and redemption history information using the remote system 140 account. The user 101 may display a transaction history, a redemption history, and/or a list of total redemption savings. The user 101 may also search with the purchase and redemption history.

An exemplary remote system 140 comprises an offer redemption module 145. The offer redemption module 145 receives the user's loyalty transaction information from the loyalty program system 130 and determine whether the user 101 has a saved manufacturer offer for the transaction or items within the transaction. In an exemplary embodiment, the loyalty transaction information comprises information identifying the user 101 (for example a loyalty program system 130 identification number, a remote system 140 account number, the user's 101 name, or some other form of identification), a transaction total, an identification of the items purchased and a price for each item. In an exemplary embodiment, the identification of the items purchased comprises information such as product title, brand information, universal product code (“UPC”), a stock keeping unit (“SKU”), a Japanese article number (“JAN”), a world product code (“WPC”), International Standard Book Number (“ISBN”), European Article Number (“EAN”), tax information, color, size, and other relevant sale information.

In an exemplary embodiment, the remote system 140 receives manufacturer offers from the manufacturer system 150. An exemplary manufacturer system 150 comprises a manufacturer device 155. The manufacturer device 155 may be a computer, mobile device (for example, notebook, computer, tablet computer, netbook computer, personal digital assistant (“PDA”), video game device, GPS locator device, cellular telephone, Smartphone or other mobile device), or other appropriate technology that includes or is coupled to a web server 157 (for example, Google Chrome, Microsoft Internet Explorer, Netscape, Safari, Firefox, or other suitable application for interacting with web page files). The manufacturer system 150 can view, register, download, upload, create offers or otherwise access the remote system 140 via a website and a network (not illustrated). The offer redemption module 145 distributes manufacturer's offers through selected network channels. In an exemplary embodiment, the network channels comprise display on cost per mille impression (“CPM”), pay per click (“PPC”), electronic correspondence, and offers near me. In an alternative exemplary embodiment, the manufacturer's offers are selectively presented to users based on the user's transaction information saved in the data storage unit 147. The manufacturer specifies the details of the offer, by selecting the type of offer, the duration, the discount amount or percentage, redemption rules, and additional pertinent details when creating the offer. In an alternative exemplary embodiment, the manufacturer offers are distributed directly by the manufacturer system 150, merchant system 110, loyalty program system 130, or a third party without remote system 140 involvement.

In an exemplary embodiment, each manufacturer offer will have one or more structured rules or conditions that the offer redemption module 145 can understand without human intervention. These rules include, but are not limited to, a purchase threshold (for example, receive $10 back on a single purchase of more than $50 from the merchant), an aggregate purchase threshold (for example, receive $10 back from the next purchase from the merchant after the accumulated purchase at merchant has reached $1000), a minimum number of purchases from the merchant (for example, receive $10 back on your tenth purchase from the merchant), a time restriction (for example, receive $10 back for a lunch-time purchase), a location restriction (for example, receive $10 back from a purchase at a specified merchant location), a maximum discount based on which the remote system 140 intelligently selects the adequate discount for each user 101 (for example, the manufacturer sets $10 off as a maximum and user A gets $1 off, while user B gets $2 off), a redemption for a particular item, an expiration date, and a redemption of a pre-paid offer that the user has purchased and saved in the user's account/wallet. In an exemplary embodiment, these rules are set by the manufacturer system 150 at the time the manufacturer is created and reviewed by the offer redemption module 145 before the manufacturer offer is applied. In an alternative exemplary embodiment, the manufacturer offer is a prepaid offer or other offer, and the offer redemption rules include an expiration date.

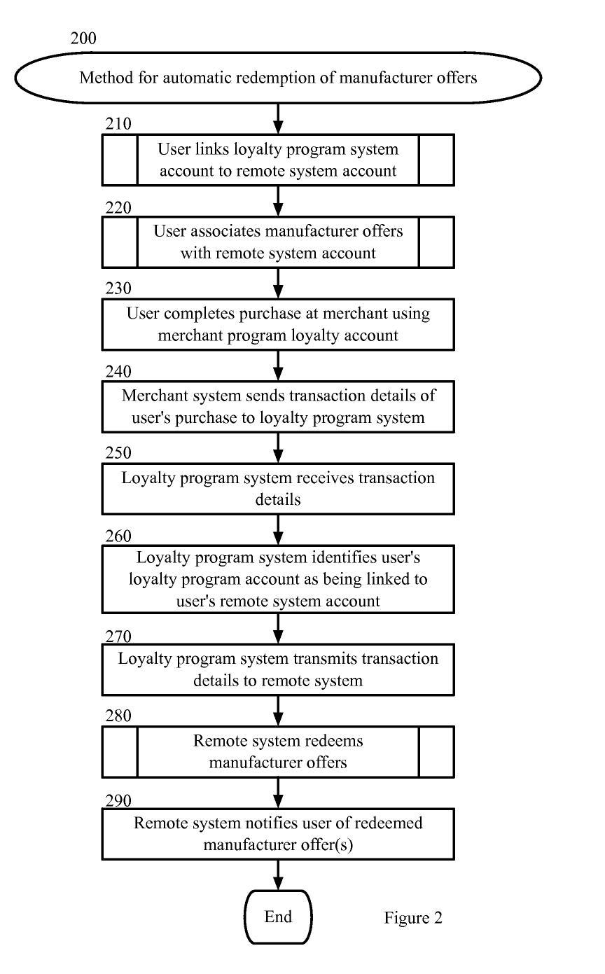

In an exemplary embodiment, the offers may include, but are not limited to, coupons, loyalty points, prepaid offers, rebates, and other forms of value added services. In an alternative exemplary embodiment, the offers are not limited to manufacturer offers. In this embodiment, the offers may comprise merchant offers, third party offers, and other types of offers. The automatic redemption of manufacturer offers is described in more detail hereinafter with reference to the methods described in FIGS. 2-7.

### System Process

FIG. 2 is a block flow diagram depicting a method for automatic redemption of manufacturer offers according to an exemplary embodiment. The method 200 is described with reference to the components illustrated in FIG. 1.

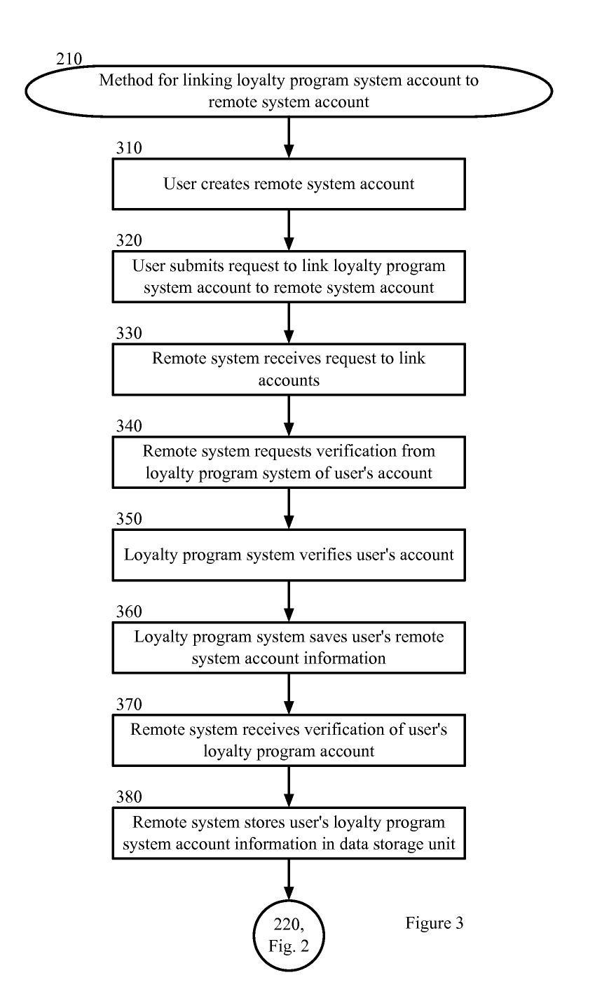

In block 210, the user 101 links his/her loyalty program system 130 account to his/her remote system 140 account. The method for linking a loyalty program system 130 account to a remote system 140 account is described in more detail hereinafter with reference to the methods described in FIG. 3.

FIG. 3 is a block flow diagram depicting a method for linking a loyalty program system 130 account to a remote system 130 account according to an exemplary embodiment, as referenced in block 210. The method 210 is described with reference to the components illustrated in FIG. 1.

In block 310, the user 101 creates a remote system 140 account. The user 101 may create the remote system 140 account at any time prior to or while requesting to link the account to the user's loyalty program system 130 account. In an exemplary embodiment, the user 101 accesses the remote system 140 via a website and a network (not shown). In an exemplary embodiment, the user 101 submits registration information to the remote system 140, including, but not limited to, name, address, phone number, e-mail address, information for one or more registered financial card accounts, including bank account debit cards, credit cards, a loyalty rewards account card, or other type of account that can be used to make a purchase (for example, card type, card number, expiration date, security code, and billing address), the financial account information redemptions are to be credited to (for example, card type, card number, expiration date, security code, billing address, financial institution account, and/or financial institution account number), and/or method for receipt of authorization message (for example, text message, e-mail message, phone call, message on smart phone application, or other communication method). In an exemplary embodiment, the user's 101 remote system 140 account information is saved in the data storage unit 147 and is accessible to the offer redemption module 145.

In an exemplary embodiment, the remote system 140 account is a digital wallet account maintained by the remote system 140. In an alternative exemplary embodiment, the user 101 may be prompted to register with the remote system 140 when the user 101 clicks on or selects a manufacturer offer. In an alternative exemplary embodiment, the user 101 may use a smart phone application to register with the remote system 140. In yet another alternative exemplary embodiment, the user 101 accesses the remote system 140 via a smart phone application.

In block 320, the user 101 submits a request to link his/her loyalty program system 130 account to his/her remote system 140 account. In an exemplary embodiment, the user's loyalty program system 130 account is a merchant-specific loyalty account. In an alternative exemplary embodiment, the user's loyalty program system 130 account is a loyalty account that services multiple merchant types or multiple merchant locations.

In an exemplary embodiment, the user 101 accesses his/her remote system 140 account and submits a request to link the accounts. In an alternative exemplary embodiment, the user 101 accesses his/her loyalty program system 130 account and requests to link the accounts.

In block 330, the remote system 140 receives the request to link the accounts. In an exemplary embodiment, the user 101 requests to link the accounts when creating the remote system 140 account and the remote system 140 processes the request when creating the user's remote system 140 account. In an alternative exemplary embodiment, the user 101 requests to link his/her loyalty program system 130 account to an existing remote system 140 account. In an alternative exemplary embodiment, direct verification is not required. For example, the user 101 may register to have data sent from the loyalty program system 130 to the remote system 140 without providing the remote system 140 with the user's loyalty program account information.

In block 340, the remote system 140 requests verification from the loyalty program system 130 of the user's loyalty program account. In an exemplary embodiment, the remote system 140 requests verification that the loyalty program system 130 account information entered by the user 101 belongs to the user and is complete. For example, the remote system 140 verifies the completeness and accuracy of the information, as well as confirms the account belongs to the user 101.

In an exemplary embodiment, the remote system 140 transmits the information received by the user 101 to the loyalty program system 130 corresponding to the account information provided. For example, the remote system 140 will transmit the user's information to the corresponding Best Buy loyalty program system 130 if the user 101 wishes to link his/her Best Buy loyalty account to his/her remote system 140 account. In an alternative exemplary embodiment, the remote system 140 transmits selected information, such as the user's name and loyalty program system 130 account information to the corresponding loyalty program system 130.

In block 350, the loyalty program system 130 verifies the user's account information. In an exemplary embodiment, the loyalty program system 130 cross-reference the information received from the remote system 140 with the user's loyalty account information to confirm the identity of the user 101 and the ability to link the loyalty account to the user's remote system 140 account.

In block 360, the loyalty program system 130 saves the user's remote system 140 account information in the data storage unit 137. In an exemplary embodiment, the loyalty program system 130 associates the user's remote system 140 account information with the user's loyalty program system 130 account information so that when the user 101 completes a loyalty program transaction, the transaction details may be forwarded to the remote system 140 for further processing.

In block 370 the remote system 140 receives verification from the loyalty program system 130 of the user's account information. In an exemplary embodiment, the loyalty program system 130 transmits an affirmative verification in response to receiving the remote system's 140 request for verification. In an alternative exemplary embodiment, the loyalty program system 130 transmits a declined verification in response to receiving the remote system's 140 request for verification. In this embodiment, the user's loyalty program system 130 account information may not have been verified or the account was not capable of being linked to the remote system 140 account.

In block 380, the remote system 140 stores the user's verified loyalty program system 130 account information in the data storage unit 147. In an exemplary embodiment, the verified loyalty program system 130 account information is associated with the user's remote system 140 account information and is accessible by the offer redemption module 145. In an alternative exemplary embodiment, the user's loyalty program system 130 account information is sent to the remote system 140 each time a transaction is received. In this embodiment, the methods described in block 380 may be omitted and/or the methods described in blocks 320 to 370 may be performed for each new transaction.

The method 210 then proceeds to block 220 in FIG. 2.

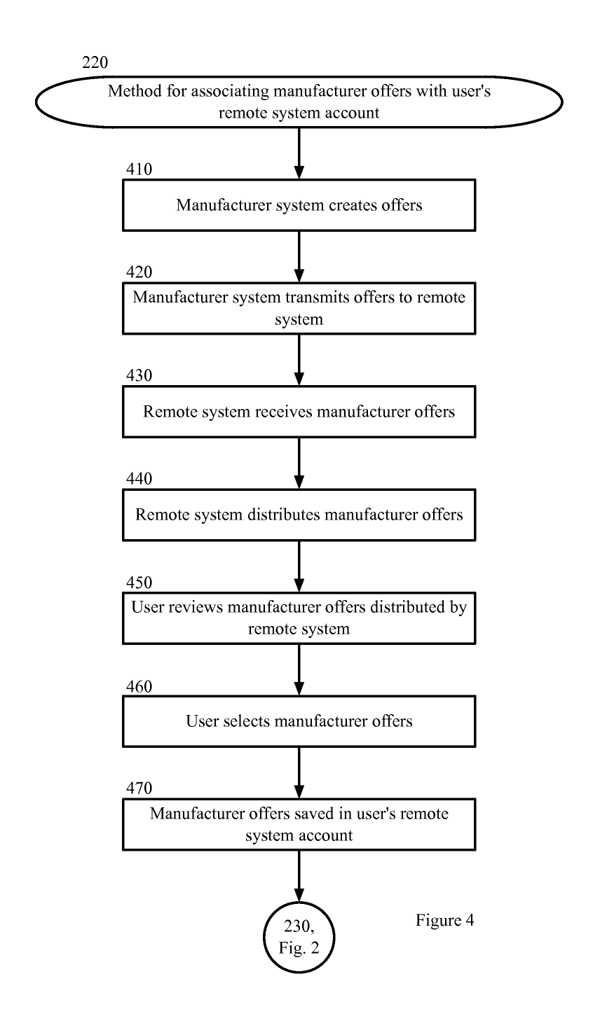

Returning to FIG. 2, in block 220, the user 101 associates manufacturer offers with his/her remote system 140 account. The method for associating manufacturer offers with a user's remote system 140 account is described in more detail hereinafter with reference to the methods described in FIG. 4.

FIG. 4 is a block flow diagram depicting a method for associating manufacturer offers with a user's remote system 140 account according to an exemplary embodiment, as referenced in block 220. The method 220 is described with reference to the components illustrated in FIG. 1.

In block 410, the manufacturer system 150 creates offers. In an exemplary embodiment, the manufacturer offers comprise coupons, loyalty reward redemptions, prepaid offers, or other forms of value added services. In an exemplary embodiment, the offers are for a specific product or group of products. For example, the offer may be for $1.00 off Tide laundry detergent or $1.00 off a Bounty product. These offers may be redeemed at any merchant that accepts manufacturer coupons. In an alternative exemplary embodiment, the offers are for a particular merchant. For example, the offer may be for $10 off a $50 purchase at Best Buy. In an alternative exemplary embodiment, the manufacturer offers comprise loyalty reward point redemptions. For example, the offer may be for 10 loyalty points for every purchase of a Bounty product. In an exemplary embodiment, the loyalty points associated with the offer have a cash value to the manufacturer system 150.

In an exemplary embodiment, the offers comprise details on how the offer can be redeemed and redemption rules. For example, the offer may comprise the identification of the item to be purchased, such as product title, brand information, universal product code (“UPC”), a stock keeping unit (“SKU”), a Japanese article number (“JAN”), a world product code (“WPC”), International Standard Book Number (“ISBN”), European Article Number (“EAN”), color, size, and other relevant sale information. In an exemplary embodiment, the offer details assist the offer redemption module 145 in matching the offer with the user's transaction details.

In an exemplary embodiment, each offer will have one or more rules or conditions associated with it. These rule include, but are not limited to a purchase threshold (for example, receive $1.00 off Tide laundry detergent that is regularly priced $5.00 or more, or $10 single purchase of more than $50 from merchant), an aggregate purchase threshold (for example, receive $10 off next purchase from a merchant after the accumulated purchase of Bounty products has reached $100), a minimum number of purchases of an item (for example, receive $10 off your tenth purchase of Bounty items), a time restriction (for example, receive $10 off a lunch-time purchase), a maximum discount based on which the remote system 140 intelligently selects the adequate discount for each user 101 (for example, the manufacturer sets $10 off as a maximum and user A gets $1 off, while user B gets $2 off), and/or a location restriction (for example, receive $10 off a purchase at a specified merchant location). In an exemplary embodiment, these rules are set by the manufacturer system 150 at the time the offer is created and reviewed by the offer redemption module 145 before the offer is applied. In an alternative exemplary embodiment, the offer is a prepaid offer and the redemption rules may include an expiration date.

In block 420 the manufacturer system 150 transmits the offers to the remote system 140. In an alternative exemplary embodiment, the manufacturer system 150 distributes the offers. In another alternative exemplary embodiment, the offers are distributed by a distribution system (not illustrated), a merchant system 110, the manufacturer system 150 or a separate third party system. In an alternative exemplary embodiment, a combination of these methods is utilized to distribute the offers.

In block 430 the remote system 140 receives the offers.

In block 440, the remote system 140 distributes the offers. In an exemplary embodiment, the offers are transmitted for distribution by the remote system 140. The offer redemption module 145 distributes manufacturer's offers through selected network channels. In an exemplary embodiment, the network channels comprise display on cost per mille impression (“CPM”), pay per click (“PPC”), electronic correspondence, and offers near me. In an alternative exemplary embodiment, the manufacturer's offers are selectively presented to users based on the user's transaction information saved in the data storage unit 147. The manufacturer specifies the details of the offer, by selecting the type of offer, the duration, the discount amount or percentage, redemption rules, and additional pertinent details when creating the offer. In an alternative embodiment, the user 101 may be prompted to register with the remote system 140 when the user 101 clicks on or selects an offer. In an alternative exemplary embodiment, the manufacturer offers are distributed directly by the manufacturer system 150, merchant system 110, loyalty program system 130, or a third party without remote system 140 involvement.

In block 450, the user 101 reviews the offers distributed by the remote system 140. In an alternative exemplary embodiment, the user 101 reviews the offers distributed by any reasonable means.

In block 460, the user 101 selects an offers to associate with the user's remote system 140 account. In an exemplary embodiment, the user 101 selects the offers by clicking on it, prepaying for the offer (if applicable), and otherwise saving it in user's remote system 140 account. In an alternative exemplary embodiment, the user may take a digital photograph of the offer using a smart phone application or scan a bar code on the offer to select it.

In block 470, the offer is saved in the user's remote system 140 account. In an exemplary embodiment, the user selected an offer distributed by the remote system 140 and the offer is selected and saved in the user's account when the user clicked on it. In an alternative exemplary embodiment, the user associates a link to the offer with the user's remote system 140 account and the remote system 140 retrieves the offer details. In yet another alternative exemplary embodiment, a smart phone application is used to associate and save the offer with the user's remote system 140 account. In an exemplary embodiment, the offer is saved in the data storage unit 147 and is accessible by the offer redemption module 145.

The method 220 then proceeds to block 230 in FIG. 2.

Returning to FIG. 2, in block 230, the user 101 completes a purchase at a merchant 110. In an exemplary embodiment, the purchase transaction comprises a cash transaction, a debit transaction, a credit transaction, a loyalty point redemption transaction, a prepaid transaction, or other form of purchase transaction. In an exemplary embodiment, the user 101 presents his/her loyalty program 130 account information when completing the purchase. In an alternative exemplary embodiment, the user presents a form of identification that allows for access to the user's loyalty program 130 account. In an alternative exemplary embodiment, the user has associated the loyalty program account 130 with the user's financial card and the loyalty program system 130 is notified of the transaction.

In block 240, the merchant system 110 sends the transaction details of the purchase to the loyalty program system 130. In an exemplary embodiment, the loyalty program is specific to a merchant or group of merchants. For example, a Best Buy loyalty program or a loyalty program for various restaurants. In an exemplary embodiment, the loyalty program information is processed outside of the payment transaction. In this embodiment, the payment is processed without interruption or dependence upon the loyalty program communication. In an exemplary embodiment, the loyalty program system 130 is a third party loyalty management system that operates independently or separately from the merchant system 110. In an alternative exemplary embodiment, the loyalty program system 130 is a component of the merchant system 130. In this embodiment, the loyalty program system 130 may be a component of the POS terminal 115, a system that operates to manage the loyalty program for a group of store (for example, a merchant system component that manages the loyalty programs for all Best Buys stores), or a system that operates to manage the loyalty program for a single store.

In an exemplary embodiment, the transaction details are transmitted to the loyalty program system 130 as part of the routine transaction process. In an exemplary embodiment, the transaction details may be transmitted automatically while the transaction is being processed. In an alternative exemplary embodiment, the transaction details are transmitted on a daily, weekly, or at other scheduled batch processing times.

In block 250, the loyalty program system 130 receives the transaction details from the merchant system 110. In an exemplary embodiment, the transaction details comprise identifying the user (for example a loyalty program identification number, a remote system account number, the user's name, or some other form of identification), a transaction total, an identification of the items purchased and a price for each item. In an exemplary embodiment, the identification of the items purchased comprises information such as product title, brand information, universal product code (“UPC”), a stock keeping unit (“SKU”), a Japanese article number (“JAN”), a world product code (“WPC”), tax information, color, size, and other relevant sale information.

In an exemplary embodiment, the loyalty program system 130 reviews the transaction details and identifies the user's loyalty program 130 account, associates with transaction details with the account and saves the information in the data storage unit 137. In an exemplary embodiment, the loyalty program system 130 completes the loyalty transaction associated with the user's purchase transaction (for example, increments the user's loyalty points for the merchant) before determining whether the user's loyalty program 130 account is associated with a remote system 140 account. In this embodiment, the redemption of manufacturer offers occurs outside of the purchase and loyalty processing transaction. In an alternative exemplary embodiment, the loyalty program system 130 makes the determination while processing the loyalty transaction. In another alternative exemplary embodiment, the loyalty program system 130 makes the determination before processing the loyalty transaction.

In block 260, the loyalty program system 130 determines that the user's loyalty program 130 account is associated with a remote system 140 account. In an exemplary embodiment, the remote system module 135 reviews the user's loyalty program 130 account information and determines that the account is linked to a remote system 140 account. In an alternative exemplary embodiment, the remote system module 135 reviews a mapping of accounts to determine the association.

In block 270, the loyalty program system 130 transmits the transaction details to the remote system 140. In an exemplary embodiment, the remote system module 135 transmits the complete transaction record to the remote system 140. In an alternative exemplary embodiment, the remote system module 135 determines which information the remote system 140 requires to process offers and transmits only the required information.

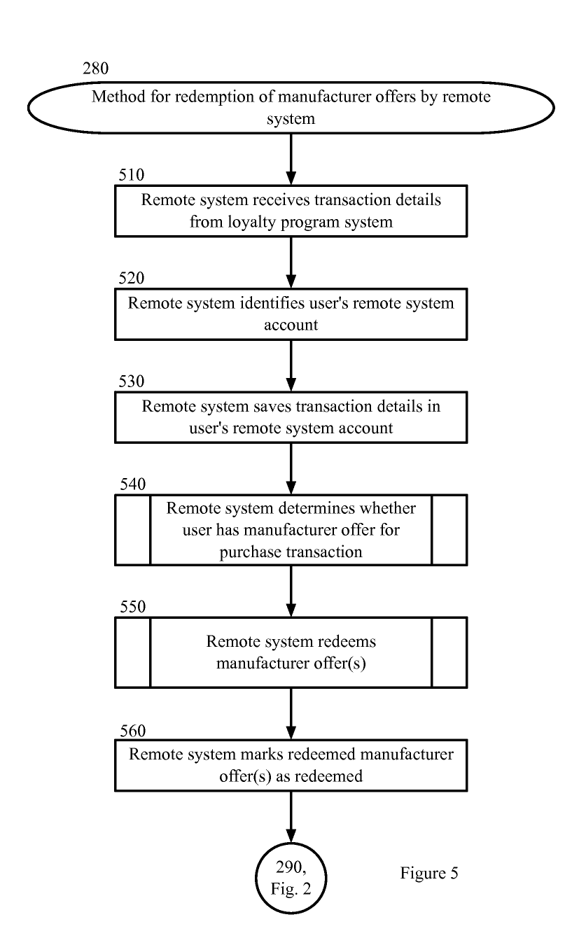

In block 280, the remote system redeems the manufacturer offers. The method for redemption of manufacturer 150 offers by the remote system 140 is described in more detail hereinafter with reference to the methods described in FIG. 5.

FIG. 5 is a block flow diagram depicting a method for redemption of manufacturer 150 offers by the remote system 140 according to an exemplary embodiment, as referenced in block 280. The method 280 is described with reference to the components illustrated in FIG. 1.

In block 510, the remote system 140 receives the transaction details from the loyalty program system 130. In an exemplary embodiment, the transaction details are received by the offer redemption module 145.

In block 520, the remote system 140 identifies the user's remote system 140 account. In an exemplary embodiment, the offer redemption module 145 reviews the transaction details, determines the identity of the user 101, and retrieves the user's remote system 140 account information from the data storage unit 147.

In block 530, the remote system 140 saves the transaction details in the user's remote system 140 account. In an exemplary embodiment, the transaction details are associated with the user's account and saved in the data storage unit 147.

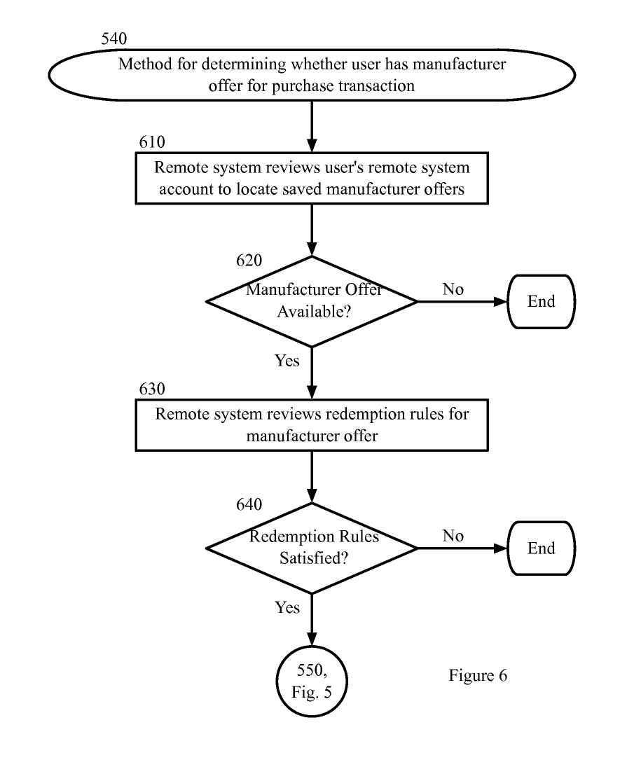

In block 540, the remote system 140 determines whether the user has a saved offer for the purchase transaction. The method for determining whether the user has a saved manufacturer 150 offer for the purchase transaction is described in more detail hereinafter with reference to the methods described in FIG. 6.

FIG. 6 is a block flow diagram depicting a method for determining whether the user 101 has a manufacturer 150 offer for a purchase transaction according to an exemplary embodiment, as referenced in block 540. The method 540 is described with reference to the components illustrated in FIG. 1.

In block 610, the offer redemption module 145 reviews the user's remote system account to locate saved manufacturer 150 offers. In an exemplary embodiment, the offer redemption module 145 retrieves all the offers saved in the user's account and determines whether any of the offers are applicable to the purchase transaction. In an alternative exemplary embodiment, the offer redemption module 145 cross-references the line item transaction details with the saved offers. In an exemplary embodiment, the transaction details comprise an identification of the items or services purchased. For example, the transaction details specify that the user purchased Tide laundry detergent. This allows the offer redemption module 145 to determine whether the user 101 has a saved manufacturer 150 offer for Tide laundry detergent.

In block 620, the offer redemption module 145 determines whether the user 101 has one or more saved offers for the purchase transaction.

If the user 101 does not have a saved offer, the method ends

If the user 101 has a saved offer for the purchase transaction, the method proceeds to block 630.

In block 630, the offer redemption module 145 reviews the redemption rules for the offer. In an exemplary embodiment, each offer has one or more redemption rules that specify when the offer may be redeemed. For example, the offer may be limited to a particular size or color. Alternatively, the offer may have an expiration date or start date.

In block 640, the offer redemption module 145 determines whether the redemption rules are satisfied by the purchase transaction. In an exemplary embodiment, the offer redemption module 145 cross-references the redemption rules with the transaction details to determine if the rules are satisfied by the purchase.

If the redemption rules are not satisfied by the purchase, the method ends.

If the redemption rules are satisfied by the purchase, the method proceeds to block 550 in FIG. 5.

In an exemplary embodiment, the methods described in block 620-640 are repeated as necessary until all applicable offers have been reviewed.

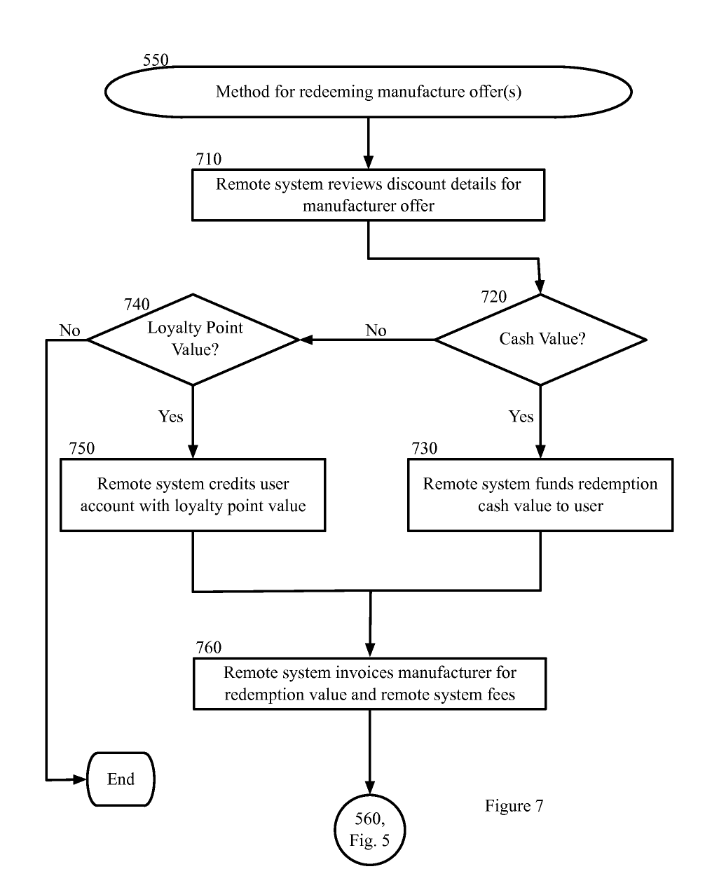

Returning to FIG. 5, in block 550, the remote system 140 redeems the manufacturer 150 offer. The method for redeeming manufacturer 150 offers is described in more detail hereinafter with reference to the methods described in FIG. 7.

FIG. 7 is a block flow diagram depicting a method for redeeming manufacturer 150 offers according to an exemplary embodiment, as referenced in block 550. The method 550 is described with reference to the components illustrated in FIG. 1.

In block 710, the remote system 140 reviews the discount details for the manufacturer 150 offer. In an exemplary embodiment, the offer redemption module 145 reviews the redemption value of the offer. In an exemplary embodiment, the redemption value is a cash value. For example, if the offer provides for $1.00 of Tide laundry detergent, the redemption value of the offer is $1.00. In an alternative exemplary embodiment, the redemption value is a loyalty point value. For example, if the offer provides receive 10 loyalty points for the purchase of Tide laundry detergent, the redemption value is 10 loyalty points.

In block 720, the offer redemption module 145 determines if the redemption value is a cash value.

If the redemption value is a cash value, the method 550 proceeds to block 730.

In block 730, the remote system 140 funds the redemption of the cash value to the user. In an exemplary embodiment, the remote system 140 credits the user's account with the cash value amount. In an alternative exemplary embodiment, the user 101 designates a financial account to have the redemptions funded to. For example, if the user 101 designates a bank account or debit card, the remote system 140 will fund the redemption value to the user's bank or debit account. In an exemplary embodiment, the funding of the redemption occurs in real time with the purchase transaction. In an alternative exemplary embodiment, the funding of the redemption occurs on a daily, weekly, or set batch processing time schedule. In an alternative exemplary embodiment, the remote system 140 notifies the loyalty program system 130 of the cash value redemption and the loyalty program system 130 pays the redemption value to the user 101. The remote system 140 invoices the manufacturer 150 for the redemption value of the offer and any applicable remote system 140 fees and reimburses the loyalty program system 130 for the redeemed value of the offer.

Returning to block 720, if the redemption value is not a cash value the method 550 proceeds to block 740.

In block 740, the offer redemption module 145 determines if the redemption value is a loyalty point value.

If the redemption value is not a loyalty point value, the method 550 ends. In an alternative exemplary embodiment, the offer redemption module 145 determines the appropriate redemption value and credits the user's account. In an alternative exemplary embodiment, the offer redemption module 145 notifies the loyalty program system 130 of the loyalty point value.

If the redemption value is a loyalty point value, the method 550 proceeds to block 750.

In block 750, the remote system 140 credits the user's account with the appropriate loyalty point value. In an exemplary embodiment, the loyalty point value is separate from any value processed by the loyalty program system 130. The user's remote system 140 account is credited with the appropriate loyalty point value. In an alternative exemplary embodiment, the offer redemption module 145 notifies the loyalty program system 130 of the loyalty point value and the loyalty point value is credited to the user's loyalty program system 130 account by the loyalty program system 130. The remote system 140 invoices the manufacturer 150 for the redemption value of the offer and any applicable remote system 140 fees and reimburses the loyalty program system 130 for the redeemed value of the offer.

In an exemplary embodiment, the methods described in blocks 710-750 repeat as necessary until all applicable offers are redeemed.

From blocks 750 and 730, the method 550 proceeds to block 760.

In block 760, the remote system 140 invoices the manufacturer 150 for the redemption value of the offer and any applicable remote system 140 fees. In an exemplary embodiment, the redemption value is a cash value and the remote system 140 invoices the merchant for the cash value of the redemption and any applicable remote system 140 fees.

In an alternative exemplary embodiment, the redemption value is a loyalty point value and the remote system 140 translates the point value to a cash value. In an exemplary embodiment, the manufacturer 150 provides a mapping of the cash value to point value when the offer is created. In an alternative exemplary embodiment, the remote system 140 determines the cash value. In an alternative exemplary embodiment, the loyalty program system 130 translates the point value to a cash value and notifies the remote system 140 of the cash value. In this embodiment, the remote system 140 may pay the loyalty program system 130 the cash value of the offer or the cash value of the loyalty points.

The method 550 then proceeds to block 560 in FIG. 5.

Returning to FIG. 5, in block 560, the remote system 140 marks the manufacturer offer(s) as redeemed. In an exemplary embodiment, the user 101 is able to redeem each offer one time, pursuant to the redemption rules specified in the offer and the offer is marked as “redeemed” after it is used. In an alternative exemplary embodiment, the user 101 is able to redeem an offer a set number of times and the offer is marked as being redeemed once on the date redeemed to track the number of times it has been redeemed.

The method 280 then proceeds to block 290 in FIG. 2.

Returning to FIG. 2, in block 290, the remote system 140 notifies the user 101 of the redeemed offer(s). In an exemplary embodiment, the user 101 specifies the preferred method of communication when creating the remote system 140 account and the offer redemption module 145 notifies the user 101 of the redemption via the preferred method of communication. In an exemplary embodiment, the offer redemption module 145 sends a real time message to user 101 via SMS that user 101 received the redemption (for example, redeemed an offer for $1.00 off Tide laundry detergent). In an alternative exemplary embodiment, the offer redemption module 455 sends a real time message to user 101 via an e-mail message that user 101 received the redemption. In another alternative exemplary embodiment, the offer redemption module 455 sends a real time message to user 101 via a smart phone application.

From block 290, the method 200 ends.

### General

Users may be allowed to limit or otherwise affect the operation of the features disclosed herein. For example, users may be given opportunities to opt-in or opt-out of the collection or use of certain data or the activation of certain features. In addition, users may be given the opportunity to change the manner in which the features are employed. Instructions also may be provided to users to notify them regarding policies about the use of information, including personally identifiable information, and manners in which each user may affect such use of information. Thus, information can be used to benefit a user, if desired, through receipt of relevant advertisements, offers, or other information, without risking disclosure of personal information or the user's identity.

One or more aspects of the exemplary embodiments may include a computer program that embodies the functions described and illustrated herein, wherein the computer program is implemented in a computer system that comprises instructions stored in a machine-readable medium and a processor that executes the instructions. However, it should be apparent that there could be many different ways of implementing the exemplary embodiments in computer programming, and the exemplary embodiments should not be construed as limited to any one set of computer program instructions. Further, a skilled programmer would be able to write such a computer program to implement an embodiment based on the appended flow charts and associated description in the application text. Therefore, disclosure of a particular set of program code instructions is not considered necessary for an adequate understanding of how to make and use the exemplary embodiments. Moreover, any reference to an act being performed by a computer should not be construed as being performed by a single computer as more than one computer may perform the act.

The exemplary systems, methods, and blocks described in the embodiments presented previously are illustrative, and, in alternative embodiments, certain blocks can be performed in a different order, in parallel with one another, omitted entirely, and/or combined between different exemplary methods, and/or certain additional blocks can be performed, without departing from the scope and spirit of the invention. Accordingly, such alternative embodiments are included in the invention described herein.

The invention can be used with computer hardware and software that performs the methods and processing functions described above. As will be appreciated by those having ordinary skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

Although specific embodiments of the invention have been described above in detail, the description is merely for purposes of illustration. Various modifications of, and equivalent blocks and components corresponding to, the disclosed aspects of the exemplary embodiments, in addition to those described above, can be made by those having ordinary skill in the art without departing from the spirit and scope of the invention defined in the following claims, the scope of which is to be accorded the broadest interpretation so as to encompass such modifications and equivalent structures.

What is claimed is:

1. A computer-implemented method for automatic offer redemption, comprising:
preparing, by a merchant computer, a payment request from a merchant for a purchase by a user from the merchant, the payment request comprising financial payment information for the user and information regarding the purchase;
submitting, by the merchant computer, the payment request to an issuer corresponding to the financial payment information to pay for the purchase in accordance with the financial payment information;
receiving, by the merchant computer, a payment authorization for the payment request from the issuer authorizing the payment for the purchase in accordance with the financial payment information;
transmitting, by the merchant computer, a loyalty point request to a computer that manages a merchant loyalty account of the user, the loyalty point request comprising details of the purchase made by the user at the merchant and an identification of the user, wherein the loyalty point request is different than the payment request;
receiving, by a remote computer management system that manages credentials associated with the user, a transaction record from the merchant loyalty account of the user, the transaction record comprising details of the purchase made by the user at the merchant and an identification of the user, wherein the transaction record is different from the payment request;
determining, by the remote computer management system, whether an offer is associated with the user's credentials, wherein the details of the purchase satisfy one or more redemption rules of the offer;
implementing, by the remote computer management system, a transaction to credit the user an amount associated with the offer, in response to determining that an offer is associated with the user's credentials and that the details of the purchase satisfy the one or more redemption rules of the offer; and
implementing, by the remote computer management system, a transaction to collect from an originator associated with the offer the amount that was credited by the remote computer management system.

2. The computer-implemented method of claim 1, wherein the user's credentials are an account managed by a remote computer management system.

3. The computer-implemented method of claim 1, wherein the merchant loyalty account of the user is an account maintained by a third party loyalty management system, and wherein the third party loyalty management system is separate from the merchant and the remote computer management system.

4. A computer-implemented method for automatic offer redemption, comprising:
receiving, by a computer that manages credentials associated with a user, a request to link a merchant loyalty account of the user to the user's credentials;
linking, by the computer, the merchant loyalty account of the user to the user's credentials;
receiving, by the computer, a transaction record from the merchant loyalty account of the user, the transaction record comprising details of a purchase made by the user at the merchant and an identification of the user;
determining, by the computer, whether an offer is associated with the user's credentials, wherein the details of the purchase satisfy one or more redemption rules of the offer;
implementing, by the computer, a transaction to credit the user an amount associated with the offer, in response to determining that an offer is associated with the user's credentials and that the details of the purchase satisfy the one or more redemption rules of the offer; and
implementing, by the computer, a transaction to collect from an originator associated with the offer the amount that was credited by the computer.

5. The computer-implemented method of claim 4, wherein the computer is a remote computer management system that manages the credentials associated with the user.

6. The computer-implemented method of claim 4, wherein the user's credentials are an account managed by a remote computer management system.

7. The computer-implemented method of claim 4, wherein the transaction record from the merchant loyalty account of the user is different than a payment transaction record and comprises details from a loyalty transaction.

8. The computer-implemented method of claim 4, further comprising:
saving, by the computer, one or more manufacturer offers to the user's credentials, the manufacturer offers comprising redemption rules and discount information.

9. The computer-implemented method of claim 4, wherein the offer is one of a prepaid offer, a coupon, and a loyalty reward.

10. The computer-implemented method of claim 4, wherein implementing the credit of the funds to redeem the offer to the user comprises instructing an issuer to credit an account of the user with the funds to redeem the offer.

11. The computer-implemented method of claim 10, wherein the account to which the offer is funded is managed by the computer.

12. The computer-implemented method of claim 4, wherein the merchant loyalty account of the user is an account maintained by a third party loyalty management system, and wherein the third party loyalty management system is separate from the merchant and the computer.

13. The computer-implemented method of claim 4, wherein the purchase made by the user at the merchant is a cash transaction.

14. The computer-implemented method of claim 4, wherein the offer is a manufacturer offer.

15. A computer program product, comprising:
a non-transitory computer-readable medium having computer-readable program instructions embodied therein that when executed by a computer perform a method for an automatic offer redemption, the computer-readable program instructions comprising:
computer-readable program instructions for receiving, by a computer that manages an account associated with a user, a request to link a merchant loyalty account of the user to the user's account;
computer-readable program instructions for linking the merchant loyalty account of the user to the user's account;
computer-readable program instructions for receiving a transaction record from the merchant loyalty account of the user, the transaction record comprising details of a purchase made by the user at the merchant and an identification of the user;
computer-readable program instructions for determining whether an offer is associated with the user's account, wherein the details of the purchase satisfy one or more redemption rules of the offer; and
computer-readable program instructions for redeeming the offer to the user in response to determining that an offer is associated with the user's account and that the details of the purchase satisfy the one or more redemption rules of the offer.

16. The computer program product of claim 15, wherein redeeming the offer to the user further comprises:
computer-readable program instructions for implementing a transaction to credit the user an amount associated with the offer.

17. The computer program product of claim 16, further comprising:
computer-readable program instructions for implementing a transaction to collect from an originator associated with the offer the amount that was credited.

18. The computer program product of claim 15, further comprising:
computer-readable program instructions for saving one or more offers to the user's account, the offers comprising redemption rules and discount information.

19. The computer program product of claim 15, wherein the merchant loyalty account of the user is an account maintained by a third party loyalty management system, and wherein the third party loyalty management system is separate from the merchant and a remote computer management system that manages the account associated with the user.

20. The computer program product of claim 15, wherein the purchase made by the user at the merchant is a cash transaction.

21. A system for providing an automatic offer redemption system, the system comprising:
one or more information processing units for executing programs; and
an engine executable on the one or more information processing units, the engine comprising:
instructions for receiving, by a computer that manages an account associated with a user, a transaction record from a merchant loyalty account of a user, the transaction record comprising details of a purchase made by the user at the merchant and an identification of the user;
instructions for determining whether an offer is associated with the user's account, wherein the details of the purchase satisfy one or more redemption rules of the offer; and
instructions for redeeming the offer to the user, in response to determining that an offer is associated with the user's account and that the details of the purchase satisfy the one or more redemption rules of the offer.

22. The system of claim 21, wherein the engine further comprises:
instructions for receiving a request to link the merchant loyalty account of the user to the user's account; and
instructions for linking the merchant loyalty account of the user to the user's account.

23. The system of claim 21, wherein redeeming the offer to the user further comprises:
instructions for implementing a transaction to credit the user an amount associated with the offer.

24. The system of claim 23, wherein the engine further comprises:
instructions for implementing a transaction to collect from an originator associated with the offer the amount that was credited.

25. The system of claim 23, wherein implementing the credit of the funds to redeem the offer to the user further comprises:
instructions for instructing an issuer to credit an account of the user with the funds to redeem the offer.

26. The system of claim 21, wherein the engine further comprises:
instructions for saving one or more offers to the user's account, the offers comprising redemption rules and discount information.

27. The system of claim 21, wherein the merchant loyalty account of the user is an account maintained by a third party loyalty management system, and wherein the third party loyalty management system is separate from the merchant and a remote computer management system that manages the account associated with the user.

28. The system of claim 21, wherein the purchase made by the user at the merchant is a cash transaction.
